(19) United States
(12) Patent Application Publication
(10) Pub. No.: US 2016/0073610 A1
(43) Pub. Date: Mar. 17, 2016

(54) TWO FINGER OR THREE FINGER PET BRUSH

(71) Applicant: Randy Jack, Wisonsin Rapids, WI (US)

(72) Inventor: Randy Jack, Wisonsin Rapids, WI (US)

(21) Appl. No.: 14/846,770

(22) Filed: Sep. 5, 2015

Related U.S. Application Data
(63) Continuation-in-part of application No. 13/865,159, filed on Apr. 17, 2013, now abandoned.
(60) Provisional application No. 61/635,124, filed on Apr. 18, 2012.

(51) Int. Cl. A01K 13/00; B25G 1/10; A46B 9/06; A46B 5/02

(52) U.S. Cl. CPC A01K 13/00; A46B 5/02; B25G 1/102; A46B 9/06; A46B 2200/1093

(57) ABSTRACT

A pet brush has an outwardly curved brush body integrally formed with a handle section. The outwardly curved brush body has a first radius of curvature at one end and a smaller, second radius of curvature at the handle section, second end. The brush body has bristles extending from the lower surface of the pet brush. The handle section extends inward from one end of the pet brush. The handle section has a spacer element and a gripping element. Two or three fingers of the user can grip the gripping element. The spacer element provides enough space for the two or three fingers to fit under the gripping element and above the brush body. Alternately, the handle section can extend from along the length of the brush body. Two or three fingers can grip the gripping section or fit sideways between the gripping section and the brush body.

### CROSS-REFERENCE TO RELATED APPLICATIONS

This application is a Continuation in Part of U.S. patent application Ser. No. 13/865,159 filed on Apr. 17, 2013, which is herein incorporated by reference. U.S. patent application Ser. No. 13/865,159 claims the benefit of U.S. Provisional Patent Application Ser. No. 61/635,124, which was filed on Apr. 18, 2012, which is herein incorporated by reference.

### BACKGROUND OF THE INVENTION

This invention relates generally to a pet brush and, more particularly, this invention is directed to a pet brush controlled by two or three fingers of the user and designed for dematting and grooming small animals.

Conventional pet brushes fall into two categories: hand brushes and handle brushes.

A hand brush is made of wood, rubber or plastic. It has an oval shape. The lower surface of the hand brush is flat with bristles sticking out to brush the animal. The upper surface can be flat or outwardly curved.

In use, the palm of the user is pressed against the oval upper surface with the thumb and fingers gripping the outer edge of the hand brush. The user then brushes the pet.

The size of the hand brush is larger than the palm of the average user. The hand brush is sometimes referred to as a palm brush.

A handle brush has a brush head connected to a brush handle. The brush head and the brush handle formed on a single axial center line. The lower surface of the brush head is usually flat with bristles sticking out to brush the animal. The upper surface of the brush head can be flat or outwardly curved. The brush handle is typically cylindrical or ovoid in shape.

In use, the palm of the user presses against the upper surface of the brush handle with the fingers gripping the sides and lower surface of the brush handle. The user then brushes the pet.

Most conventional pet brushes have a large flat brushing surface. Small animals have curved and irregular body surfaces. It becomes problematic for a user to manipulate a large flat brush to quickly and adequately brush and groom a small animal, such as a small dog or cat.

Large brushes allow small animals to see the brush, potentially scaring the small animal. Large brushes may cause discomfort to a small animal by large numbers of bristles pulling at the small animal's hair and attached skin.

It is difficult for large brushes to reach small areas on a small animal and it is equally difficult for large brushes to groom small areas on a small animal.

Conventional pet brushes cannot be easily carried hands-free. Conventional pet brushes cannot be easily carried on a user's belt or in a user's pocket without a separate traveling carry case.

Conventional brushes take up large areas when resting on flat surfaces. Gripping the brush leads to hand wrist fatigue. The bristles are either down and possibly being broken or misaligned or are up, making it difficult to pick up the brush.

Extended handle brushes lead to repetitive stress to arms, wrists and hands of the user. When grooming a pet, the brush is typically pushed or pulled along a direction that is generally perpendicular to the handle axis. This repetitive stress alone can cause considerable strain and fatigue, especially where a user spends a good deal of time brushing.

U.S. Pat. No. 8,042,216 to Jochim has a two part pet brush with a handle grip and a removable and replaceable bristle base. The hand grip has finger slots and a thumb slots to position the hand on the grip.

The handle grip of the Jochim patent has a collar partially around the lower surface to receive the bristle base grip. The bristle base has a collar partially around the upper surface to receive the hand grip. Each collar prevents the pet brush from being used as a hand brush with the hand unable to grip the bristle base.

The Jochim patent must be gripped with a closed fist. The finger slots lock the user into the grip and locks the user into the forward and backward only brushing motion. The patent states that sideways motion stresses the pet.

The Jochim patent pet brush brushes substantially parallel to the length of the brush in a forward and backward motion.

The Jochim patent pet brush has removable bristle bases with each bristle base having different bristles performing a single different brush function.

The Jochim has a quick release and a spring latch to separate the two sections of a hand grip from the bristle base.

The Jochim patent is a large invasive brush intended for large pets. It is too large to use effectively on small pets and too large to use on hard to reach areas of small pets. The motion of the pet brush is mainly brushing linearly back and forth in one direction which limits the use on a small pet and increases stress during grooming for a small pet.

The purpose of this present invention is to provide a more effective pet brush for small animals.

An object of this present invention is to provide a pet brush which reduces the stress and fatigue of the user.

Another object of this invention is to provide a pet brush that can be gripped and controlled by two or three fingers.

Another object of this invention is to provide a pet brush that has two different bristles for dematting and for grooming.

Another object of this invention is to provide a pet brush which is a handle brush and a hand brush.

### SUMMARY OF THE INVENTION

This invention discloses a pet brush which has an outwardly curved brush body integrally formed with a handle section. The brush body has bristles extending from the lower surface of the pet brush on the outward curve. The handle section extends inward from one end of the upper surface of the brush body of the pet brush.

The outwardly curved brush body has a first section with a first radius of curvature at one end and a second section with a second radius of curvature at the handle section, the second end. The second radius of curvature is smaller than the first radius of curvature.

The handle section has a spacer element and a gripping element. Two or three fingers of the user can grip the upper surface of the gripping element while the first digits or the first and second digits of the two or three fingers will curl under to grip the lower surface of the gripping element. The spacer element provides enough space for the first digits of the two or three fingers to fit under the lower surface of the gripping element and above the upper surface of the brush body.

The lower gripping surface of the gripping element can have ridges, etched ridges, dimples, reversed dimples or a tactile or sticky surface for improved gripping. The lower gripping surface of the gripping element can be formed of a different plastic or polymer material (from the rest of the pet brush) for improved gripping.

Alternately, the brush body of the pet brush can have the same radius of curvature from the first end to the second end with the handle section.

The bristles of the pet brush can be formed of different bristle materials. The brush body of the pet brush can have a first row of dematting bristles followed by rows of untangling and/or grooming bristles to better brush a pet.

The pet brush can hook onto a belt or pocket for carrying or freeing both hands of the user. The gripping element of the handle section of the pet brush is inside the belt, the spacer element is on top of the belt and the brush body is outside the belt. The same configuration also allows the pet brush to be hooked to a pocket.

The pet brush of the present invention can rest on any flat surface with the spacer element providing a base or the first end of the brush body and the upper surface of the gripping element providing a base.

This invention also discloses a pet brush which is both a handle brush and a hand brush. The pet brush has an outwardly curved brush body integrally formed with a handle section. The brush body has bristles extending from the lower surface of the pet brush.

A vertical spacer element with an attached horizontal element extends from the upper surface of the brush body positioned 20 to 30 percent of the length of the pet brush from one end of the pet brush, the second end.

The handle brush pet brush will have the horizontal element as a gripping element. In the first gripping, method, two or three fingers of the user can grip the upper surface of the gripping element while the first digits or the first and second digits of the two or three fingers will curl under to grip the lower surface of the gripping element.

In the second gripping method, the spacer element provides enough space for the first digits of the two or three fingers to slide laterally under the lower surface of the gripping element and above the upper surface of the brush body.

The hand brush pet brush will have the horizontal element as a finger restraining element. Two or three fingers of the user can grip the upper surface of the brush body with the index finger gripping the brush body not under the finger restraining element.

The spacer element provides enough space for the middle finger or the middle finger and ring finger to fit between under the lower surface of the finger restraining element and the upper surface of the brush body.

The upper surface of the brush body next to the spacer element, but not underneath the spacer element, the extension, provides a finger rest for the finger in the second gripping method. One finger or two fingers will be between the gripping element and the brush body and one finger will be on the extension, the finger rest. The fingers will straddle the spacer element.

### BRIEF DESCRIPTION OF THE DRAWINGS

A more detailed understanding of the present invention, as well as other objects and advantages thereof not enumerated herein, will become apparent upon consideration of the following detailed description and accompanying drawings, wherein:

FIG. 1 is a side view of the first embodiment of the pet brush of the present invention.

FIG. 2 is a top view of the pet brush of the present invention of FIG. 1.

FIG. 3 is a side view of fingers gripping the handle section of the pet brush of the present invention.

FIG. 4 is a top view of two fingers gripping the handle section of the pet brush of the present invention of FIG. 3.

FIG. 5 is a side view of the thumb resting on the brush body of the pet brush of the present invention of FIG. 4.

FIG. 6 is a side view of the ring finger and the little finger resting on the brush body of the pet brush of the present invention of FIG. 4.

FIG. 7 is a top view of three fingers gripping the handle section of the pet brush of the present invention of FIG. 3.

FIG. 8 is a side view of an alternate embodiment of fingers gripping the handle section of the pet brush of the present invention.

FIG. 9 is a side view of the pet brush of the present invention with one radius of curvature.

FIG. 10 is a side view of two different bristles in the brush body of the pet brush of the present invention.

FIG. 11 is a side view of the pet brush of the present invention hooked to a belt.

FIG. 12 is a side view of the pet brush of the present invention resting on a flat surface with the spacer element as its base.

FIG. 13 is a side view of the pet brush of the present invention resting on a flat surface with the first end of the brush body and the upper surface of the gripping element as its base.

FIG. 14 is a side view of the second embodiment of the pet brush of the present invention.

FIG. 15 is a top view of the pet brush of the present invention of FIG. 14.

FIG. 16 is a side view of a two finger handle pet brush of the present invention.

FIG. 17 is a top view of a two finger handle pet brush of the present invention.

FIG. 18 is a top view of a two finger handle pet brush of the present invention.

FIG. 19 is a side view of a two finger hand pet brush of the present invention.

FIG. 20 is a top view of a two finger hand pet brush of the present invention.

FIG. 21 is a side view of a three finger hand pet brush of the present invention.

FIG. 22 is a top view of a three finger hand pet brush of the present invention.

### DETAILED DESCRIPTION OF DRAWINGS

The pet brush of the present invention has two embodiments. The first embodiment of the pet brush has a first over the top gripping method. The second embodiment which is a variation of the first embodiment has the same first over the top gripping method and a second sideways lateral gripping method.

The pet brush of the first embodiment has an outwardly curved brush body with bristles on the lower surface with a handle section at one end of the upper surface. The handle section has a spacer element extending from the upper surface of the brush body. A gripping element extends from the other end of the spacer element over the upper surface of the brush body. The handle is a reverse L shape.

The user will grip the gripping element in an over the top method with two or three fingers reaching around the gripping element to fit between the upper surface of the brush body and the lower surface of the gripping element.

The second embodiment of the pet brush is the same as the first embodiment except the handle section had been positioned 20 to 30 percent of the length of the pet brush from one end of the pet brush, the second end. The upper surface of the brush body not covered by the gripping element is the extension or finger rest.

The user in the second embodiment will grip the gripping element in the same over the top method as the first embodiment.

Additionally, the user can insert two or three finger sideways laterally between the brush body and the gripping element as a second gripping method. One finger or two fingers will be between the gripping element and the brush body and one finger will be on the extension, the finger rest. The fingers will straddle the spacer element.

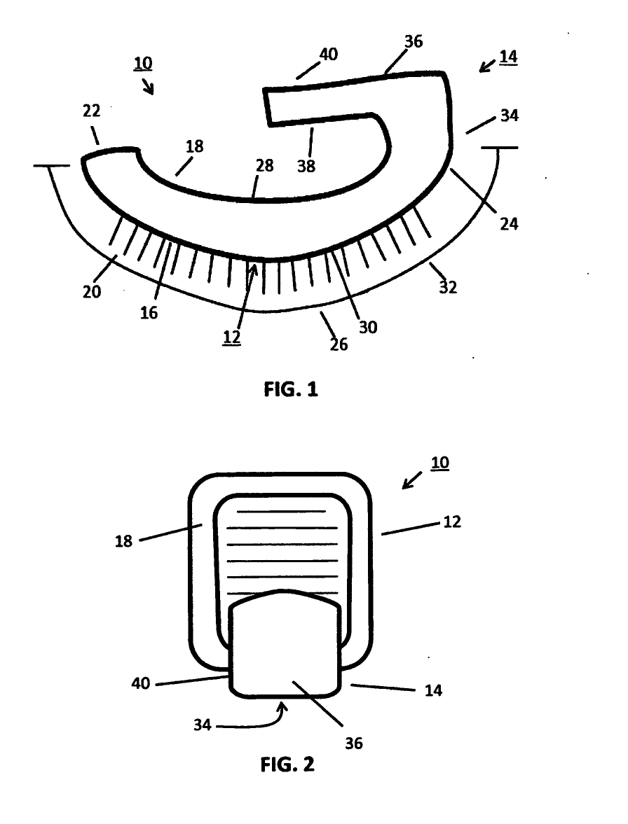

FIGS. 1 and 2 show the first embodiment of the pet brush 10 of the present invention with an outwardly curved brush body 12 integrally formed with a handle section 14. The brush can be formed of a plastic or polymer material. The brush is designed to groom small animals such as cats or small dogs or the like. The brush and its brush body and handle section are molded in one piece. The brush body and the handle section are not removable. The brush body and the handle section are permanently connected.

The outwardly curved brush body 12 has a lower surface 16 and an upper surface 18. Bristles 20 are attached to the lower surface 16 and extend into the brush body 12 of the pet brush 10. The bristles can be formed of metal wire such as stainless steel, bronze, silver, carbon steel or other materials; synthetic materials such as nylon, carbon fiber, polyester, polyethylene, polypropylene, PTFE, PVC, rubber, or other materials; vegetable fibers; and animal hair fibers; or a combination of two or more different bristle materials. The bristles can be formed with different bristle sizes, lengths, thickness or density in rows, columns, patterns or random. The bristles can be formed of cone shaped rubber type material

The brush body has a first end 22 and second end 24. The handle section 14 is integrally connected at an angle to the second end 22 of the brush body 12.

The length of the brush body of the pet brush is approximately 3½ inches with a width of 2 inches. The rise of the curve of the brush body is 1 to 2 inch on both ends. The pet brush is small so that only 2 or 3 fingers are needed to control the pet brush to groom and brush small pets or hard to reach areas.

The brush body 12 has an outward curve. This curve can also be described as convex or bow.

The brush body 12 has a first section 26 of the lower surface with a first radius of curvature at the first end 22 of the brush body 12 extending past the midpoint 28 of the brush body to a transition point 30 on the brush body. The brush body 12 has a second section 32 of the upper surface with a second radius of curvature from the transition point 30 (past the midpoint 28 of the brush body) to the second end 24 of the brush body. This second radius of curvature is different from the first radius of curvature. This second radius of curvature is smaller than the first radius of curvature.

The handle section 14 has a vertical or spacer element 34 and a horizontal or gripping element 36 in a reverse L-shape.

The spacer element 34 extends away from the upper surface 18 of the second end 24 of the brush body 12. The gripping element 36 extends laterally from the spacer element 34 above the upper surface 18 of the brush body 12. The spacer is approximately ¼ inch thick.

The spacer element 34 can be slightly outwardly curved or flat. The gripping element 36 can be flat or slightly outwardly curved. The gripping element 36 has a lower surface 38 and an upper surface 40.

The gripping element 36 is approximately planar with the first end 22 of the brush body 12 or perpendicular with the upper surface 18 of the brush body 12 adjacent to the first end of the brush body.

The spacer element 34 is at an approximate angle of 80 to 135 degrees to the gripping element 36 and is angled relative to the upper surface 18 of the second end 24 of the brush body 12. The spacer element and the gripping element form an inverted L shape.

The spacer element 34 has a height greater the average depth of the fingers of the user. This height allows the fingers to grip the lower surface of the gripping element.

The gripping element has a smooth surface with no finger or thumb slots.

The lower surface 38 of the gripping element 36 will be spaced from the nearest adjacent upper surface 18 of the brush body 12 by a distance of 1 to 1½ inches to fit the fingers of an average adult male between the surfaces of the gripping element and the brush body. The spacing allows the fingers gripping the lower surface of the gripping element to fit between the gripping element and the upper surface of the brush body.

The gripping element 36 has a width greater than the width of the three fingers (the index finger, the middle finger and the ring finger) of the user. This width allows two or three fingers to grip the gripping element.

The lower surface 38 of the gripping element has a length equal to or greater than the first digit of the middle finger (the longest finger) of the user. This length allows the fingers gripping the gripping section by the first digit or the first and second digit.

The upper section 18 of the brush body has a length greater than the first two digits of the middle finger (the longest finger) of the user. This length allows the finger gripping the gripping section to fit within the curve of the brush body.

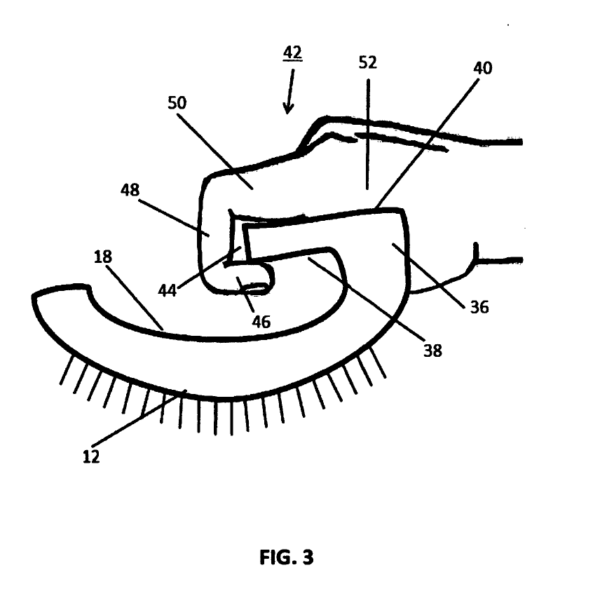

In use, as shown in FIG. 3, the index finger 42 curls around the upper surface 40, the front side 44 and under the lower surface 38 of the gripping element 36. For ease of understanding, the thumb and other fingers are not shown in this Figure. However, the digits of each finger in the two finger or three finger operation will be positioned and function as the digit of the index finger.

The first digit 46 of the index finger 42 will grip the lower surface 38 of the gripping element 36 of the handle section 14. The spacer element 34 is high enough so the index finger fits between the lower surface 38 of the gripping element and the upper section 18 of the second section 28 of the brush body 12. The upper surface of the brush element and the gripping element are long enough for one digit of the fingers to fit under the gripping element

The second digit 48 of the index finger 42 grips the front section 44 of the gripping element 36.

The third digit 50 of the index finger 42 and possibly a portion of the upper palm 52 (if the user has a small hand) will grip the upper surface 40 of the gripping element 36.

FIG. 3 shows one digit of the fingers gripping the lower surface of the gripping element of the handle section of the pet brush of the present invention.

The gripping element of the handle section of the pet brush can be gripped by two finger (the index finger and the middle finger) or three fingers (the index finger, the middle finger and the ring finger) of the user.

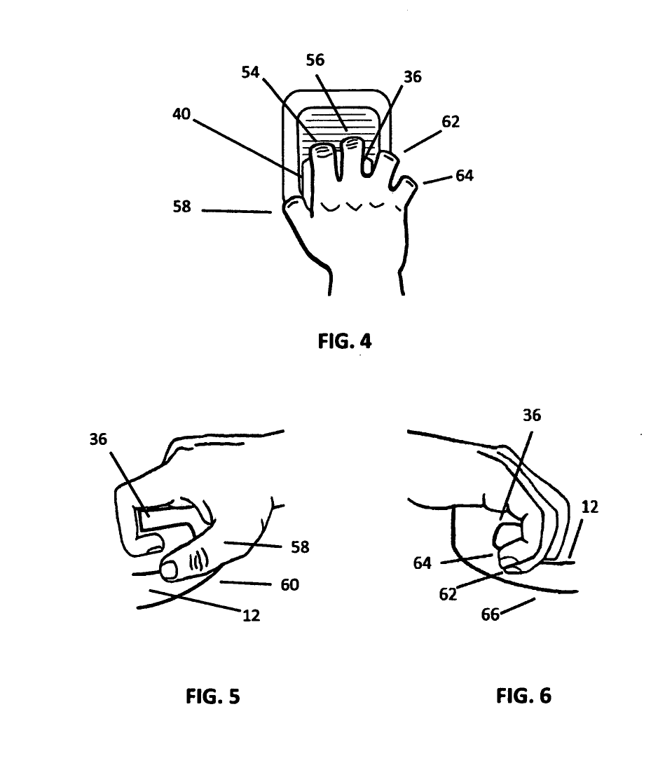

As shown in the FIG. 4, the two fingers of the index finger 54 and the middle finger 56 grip the upper surface 40 of the gripping element 36.

The thumb 58 of the user will rest on the index finger 54 or rest on the first side 60 of the brush body 12 as shown in the FIG. 5. The ring finger 62 and the little finger 64 can rest either on the second side 66 of the brush body 12 as shown in the FIG. 6; or the little finger will rest on the ring finger and the ring finger, will rest on the middle finger; or the ring finger can rest on the second side of the brush body and the ring finger will rest on the middle finger. Neither the thumb nor the ring finger nor the little finger will grip the handle.

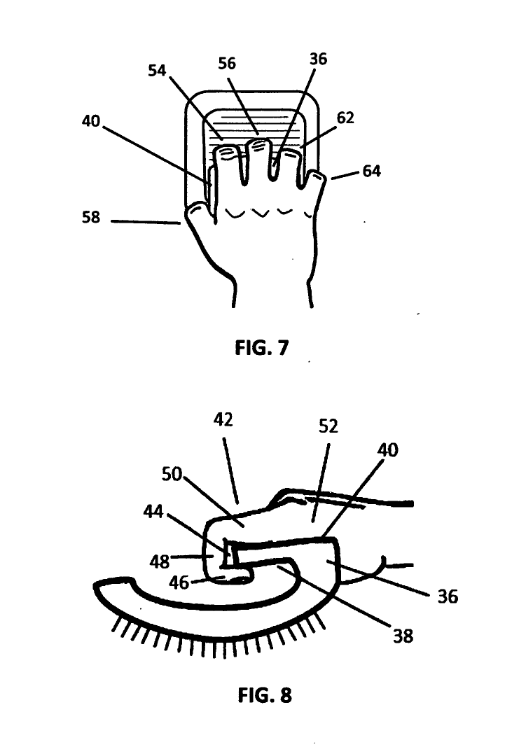

As shown in FIG. 7, the three fingers of the index finger 42, the middle finger 56 and the ring finger 62 grip the upper surface 40 of the gripping element 36.

The thumb 58 of the user will rest on the index finger or rest on the first side of the brush body as shown previously. The little finger 64 can rest either on the second side of the brush body as shown previously; or the little finger will rest on the ring finger. Neither the thumb nor the little finger will grip the handle.

Alternately, as shown in FIG. 8, the index finger 42 curls around the upper surface 40, the front side 44 and under the lower surface 38 of the gripping element 36. For ease of understanding, the thumb and other fingers are not shown in this Figure. However, the digits of each finger will be positioned and function as the digit of the index finger.

The first and second digits 46, 48 of the index finger 42 will grip the lower surface 38 of the gripping element 36 of the handle section 14. The upper surface of the brush element and the gripping element are long enough for two digits of the fingers to fit under the gripping element.

The third digit 50 of the index finger 42 grips the front section 44 of the gripping element 36.

A portion of the upper palm 52 will grip the upper surface 40 of the gripping element 36.

The gripping element of the handle section of the pet brush can be gripped by two finger (the index finger and the middle finger) or three fingers (the index finger, the middle finger and the ring finger) of the user.

The thumb and fingers will grip the sides of the brush body or rest against other fingers as detailed in the previous two figures.

FIG. 8 shows two digits of the fingers gripping the lower surface of the gripping element of the handle section of the pet brush of the present invention.

The two or three finger grip on the gripping element of the handle section of the pet brush of the present invention permits downward, upward or sideways motion of the bristles on the brush. This provides a gentle, effective brushing and grooming of the small animal.

The two or three finger grip on the gripping element of the handle section of the pet brush of the present invention allows the pet brush to reach and groom small areas on the pet's hair. The brush basically becomes part of the hand and fingers which hides the pet brush somewhat to make it less threatening when approaching various pets for grooming.

The pet brush of the present invention has no extending handle and is a more compact design with a comparable size bristle section.

Extended handle brushes lead to repetitive stress to arms, wrists and hands of the user. The brush is typically pushed or pulled along a direction that is generally perpendicular to the handle axis during grooming. This can cause considerable strain and fatigue, especially where a user spends a good deal of time brushing.

The pet brush of the present invention the hand, wrist and arm of the user can move in substantially the same downward, upward or sideways direction in which the brush is moved. In this way, hand, wrist or arm fatigue during operation can be avoided due to this positioning and minimal actuation of wrist muscles during usage.

The lower gripping surface of the gripping element can have ridges, etched ridges, dimples, reversed dimples or a tactile or sticky surface for improved gripping. The lower gripping surface of the gripping element can be formed of a different plastic or polymer material (from the rest of the pet brush) for improved gripping.

The pet brush can be operated by either the left hand or the right hand in the over the handle grip of the gripping element.

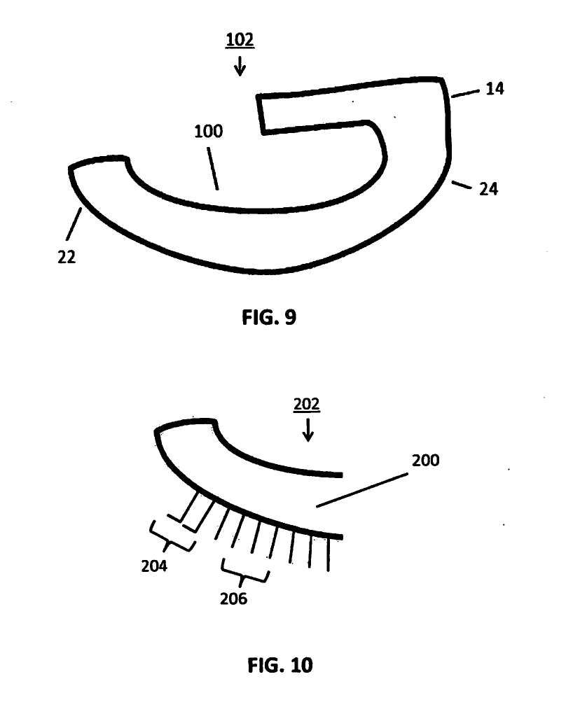

As shown in FIG. 9, the brush body 100 of the pet brush 102 can have the same radius of curvature from the first end 22 to the second end 24 with the handle section 14. The pet brush 102 is otherwise the same as the pet brush 10 of the previous Figures.

As noted, the bristles can be formed of different bristle materials. As shown in FIG. 10, the brush body 200 of the pet brush 202 has a first row of dematting bristles 204 followed by rows of grooming bristles 206 to better brush a pet. The dematting bristles will be at the initial contact with the pet hair. The brush body can have multiple rows of dematting bristles followed by rows of untangling and/or grooming bristles to better brush a pet.

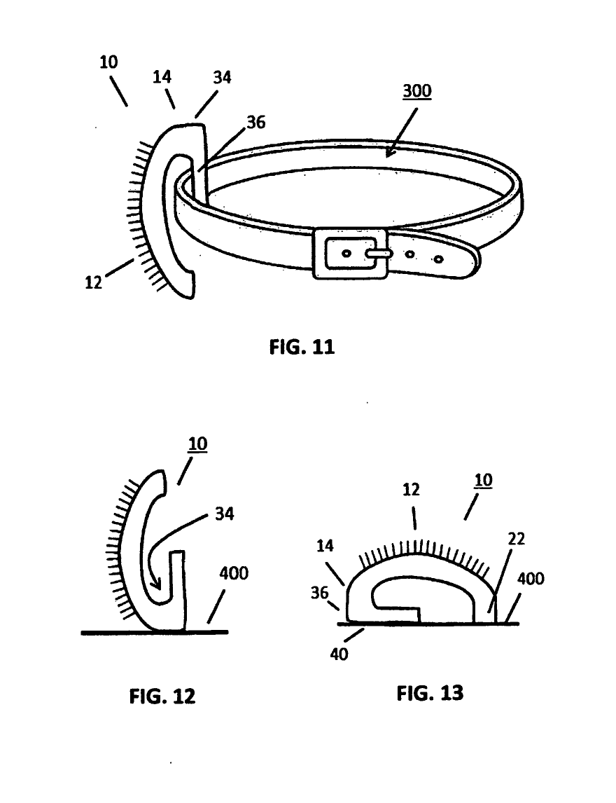

The pet brush 10 can hook onto a belt 300 or pocket for carrying or freeing both hands of the user. As shown in FIG. 11, the gripping element 36 of the handle section 14 of the pet brush is inside the belt 300, the spacer element 34 of the handle section 14 is on top of the belt 200 and the brush body 12 is outside the belt. The same configuration also allows the pet brush to be hooked to a pocket.

The pet brush 10 of the present invention can easily rest on any flat surface 400. As shown in FIG. 12, the pet brush 10 can be positioned with the spacer element 34 providing a base to rest on the flat surface 400. As shown in FIG. 13, the pet brush 10 can be positioned with the first end 22 of the brush body 12 and the upper surface 40 of the gripping element 36 of the handle section 14 providing a base to rest on the flat surface 400. Alternately, the pet brush 10 can be positioned with the first end 22 of the brush body 12 and the back side 402 of the gripping element 36, adjacent to the spacer element, of the handle section 14 providing a base to rest on the flat surface 400.

The dimensions of the pet brush of the present invention are a length of 3.5 to 4.5 inches with a width of 2 to 4 inches.

The base thickness without the bristles is ½ to ¾ of an inch. The bristles extend out ½ to 1 inch from the bottom of the pet brush.

The rise of the pet brush from the horizontal is 1 inch off the handle. The horizontal rise of the pet brush is 1⅝ inch at the other end.

The handle width, the spacer width and the gripping element width are 1½ to 2¾ inches.

The space between the bottom of the horizontal part of the handle and the bottom of the inside curve of the pet brush is 1 inch to 1½ inches.

The first radius of curvature and the second radius of curvature of the pet brush are between 10 inches and 36 inches. In that range, the first radius of curvature can be different from the second radius of curvature. Also in that range, the first radius of curvature can be the same as the second radius of curvature providing a single radius of curvature for the pet brush.

The average length of human fingers is 3 to 4 inches for the index finger, 3½ to 4½ for the middle finger, 3½ to 4½ for the ring finger, and 2½ to 3½ for the little finger. These average fingers will fit over and under the gripping element.

The brush material and the bristles material of the pet brush of the present invention allow the pet brush to be cleaned and/or disinfected in hot water, alcohol or other cleaning and/or disinfecting liquids.

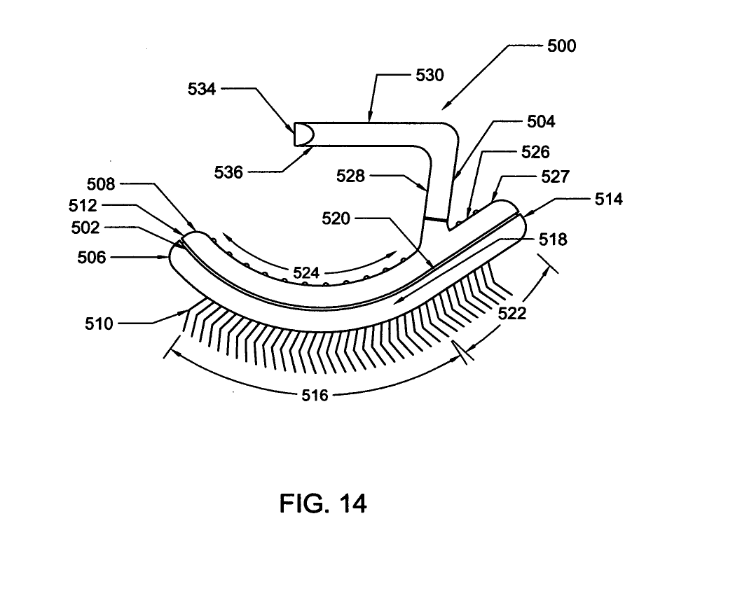

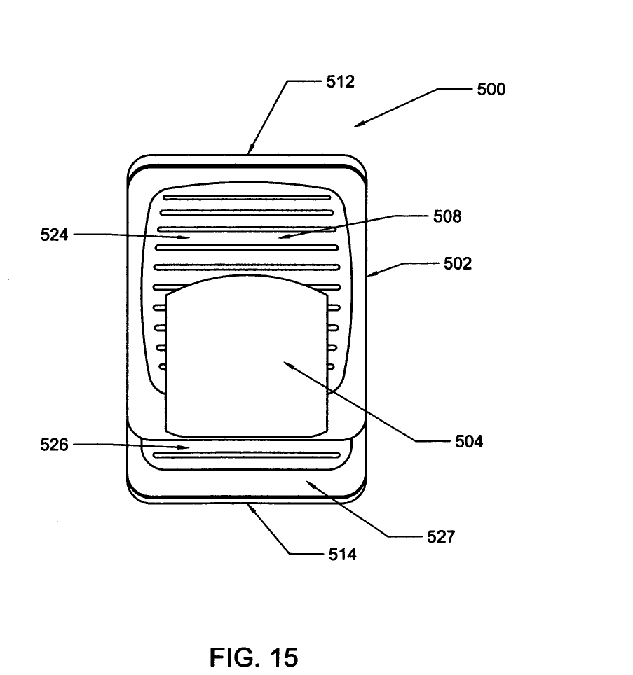

The second embodiment of the pet brush 500 in FIG. 14 and FIG. 15 is a variation of the first embodiment of the pet brush in FIGS. 1 and 2. The handle is integrally formed with the upper surface of the brush body from the second end of the pet brush to a point approximately 20 to 40 percent forward along the length of the brush body. The handle is therefore at a point approximately 80 to 60 percent backward along the length of the brush body from the first end of the pet brush.

The handle divides the upper surface of the brush body into a first longer section between the first end of the pet brush and the handle and a second smaller section between the handle and the second end of the pet brush.

The length of the brush body of the pet brush is approximately 3½ inches with a width of 2 inches. The rise of the curve of the brush body is 1 to 2 inch on both ends. The pet brush is small so that only 2 or 3 fingers are needed to control the pet brush to groom and brush small pets or hard to reach areas.

The lower surface of the gripping element will be spaced from the nearest adjacent upper surface of the brush body by a distance of 1 to 1½ inches to fit the fingers of an average adult male between the surfaces of the gripping element and the brush body.

The first section of the upper surface of the brush body will be 2¾ to 2 inches long. The second section of the upper surface of the brush body will be ¾ to 1½ inch long.

The pet brush now can function as both a handle brush with the fingers providing an over grip on the handle and as a hand brush with the index finger and the middle and ring fingers between the handle gripping the brush body.

Positioning the handle between the thumb and fingers on the pet brush allows for better control of the brush while brushing the pet. Positioning the fingers between the upper surface of the brush body and the lower surface of the horizontal element of the handle allows for a firmer grip on the pet brush. Positioning the fingers between the upper surface of the brush body and the lower surface of the horizontal element of the handle allows for a less stressful grip by the brush holder using a natural petting motion.

The pet brush is both a handle brush and a hand brush. The pet brush is held in one direction as a handle brush and is held in a sideways direction as a hand brush.

FIGS. 14 and 15 show the second embodiment of the pet brush 500 of the present invention with an outwardly curved brush body 502 integrally formed with a handle section 504. The brush can be formed of a plastic or polymer or rubber material. The brush is designed to groom small animals such as cats or small dogs or the like.

The outwardly curved brush body 502 has a lower surface 506 and an upper surface 508. Bristles 510 are attached to the lower surface 506 and extend into the brush body 502 of the pet brush 10. The bristles can be formed of metal wire such as stainless steel, bronze, silver, carbon steel or other materials; synthetic materials such as nylon, carbon fiber, polyester, polyethylene, polypropylene, PTFE, PVC, rubber, or other materials; vegetable fibers; and animal hair fibers; or a combination of two or more different bristle materials. The bristles can be formed with different bristle sizes, lengths, thickness or density in rows, columns, patterns or random. The brush moves the bristles through the hair or fur of the pet so that the bristles brush and groom the hair or fur of the pet.

The brush body has a first end 512 and second end 514.

The brush body 502 has an outward curve. This curve can also be described as convex or bow.

The lower surface of the brush body 502 has a first lower section 516 with a first radius of curvature at the first end 512 of the brush body 502 extending past the midpoint 518 of the brush body to a transition point 520 on the brush body. The brush body 502 has a second lower section 522 with a second radius of curvature from the transition point 520 (past the midpoint 518 of the brush body) to the second end 514 of the brush body. This second radius of curvature is different from the first radius of curvature. This second radius of curvature is smaller than the first radius of curvature.

The handle 504 is integrally connected at an angle to the upper surface of the brush body. The handle is positioned between the midpoint and the second end of the brush body. The handle is positioned to a point approximately 20 to 40 percent forward along the length from the second end and a corresponding approximately 80 to 60 percent backward along the length from the first end of the brush body.

The handle divides the upper surface of the brush body into a first section 524 between the first end of the brush body and the handle and a second section 526 between the handle and the second end of the brush body. This second section is 526 has an upper surface 527, which is the extension or finger rest, and is not covered by the gripping element.

The handle is reverse L-shaped with a vertical element 528 and a horizontal element 530.

The vertical element extends away from the upper surface of the second end of the brush body. The horizontal element extends laterally from the spacer element above the upper surface of the brush body towards the front end of the brush body. The horizontal element partially overhangs the first section of the upper surface of the brush body.

The vertical element 528 of the handle functions as a spacer element to separate the upper surface of the brush body from the lower surface 532 of the horizontal element 530. The vertical element can be slightly outwardly curved towards the back end of the brush body or be flat. The horizontal element can be flat or slightly curved upwardly (away from the brush body) at the end. The vertical element has a lower surface 532 and an upper surface 534.

The vertical element 36 is approximately 120 to 135 degrees from first section of the upper surface of the brush body or therefore 60 to 45 degrees from the second section of the upper surface of the brush body.

The vertical element is at an approximate right angle to the horizontal element. The vertical element and the horizontal element form an inverted L shape relative to the brush body.

The pet brush of the second embodiment can be a handle brush like the pet brush of the first embodiment.

The vertical element of the handle will be a spacer element and the horizontal element will be a gripping element.

The spacer element extends away from the upper surface near the second end of the brush body. The gripping element extends laterally from the spacer element above the upper surface of the brush body.

The spacer element can be slightly outwardly curved or flat. The gripping element can be flat or slightly outwardly curved. The gripping element has a lower surface and an upper surface.

The gripping element is approximately planar with the first end of the brush body or perpendicular with the upper surface of the brush body adjacent to the first end of the brush body.

The spacer element is at an approximate right angle within 10 degrees plus or minus to the gripping element and is angled relative to the upper surface of the second end of the brush body. The spacer element and the gripping element form an inverted L shape.

The spacer element has a height greater the average depth of the fingers of the user. This height allows the fingers to grip the lower surface of the gripping element. The height fits the fingers of an average adult male between the surfaces of the gripping element and the brush body.

The lower surface of the gripping element will be spaced from the nearest adjacent upper surface of the brush body by a distance exceeding the depth of the average fingers of the user. The spacing allows the fingers gripping the lower surface of the gripping element to fit between the gripping element and the upper surface of the brush body.

The gripping element has a width greater than the width of the three fingers (the index finger, the middle finger and the ring finger) of the user. This width allows two or three fingers to grip the gripping element.

The lower surface of the gripping element has a length equal to or greater than the first digit of the middle finger (the longest finger) of the user. This length allows the fingers gripping the gripping section by the first digit or the first and second digit.

The upper section of the brush body has a length greater than the first two digits of the middle finger (the longest finger) of the user. This length allows the finger gripping the gripping section to fit within the curve of the brush body.

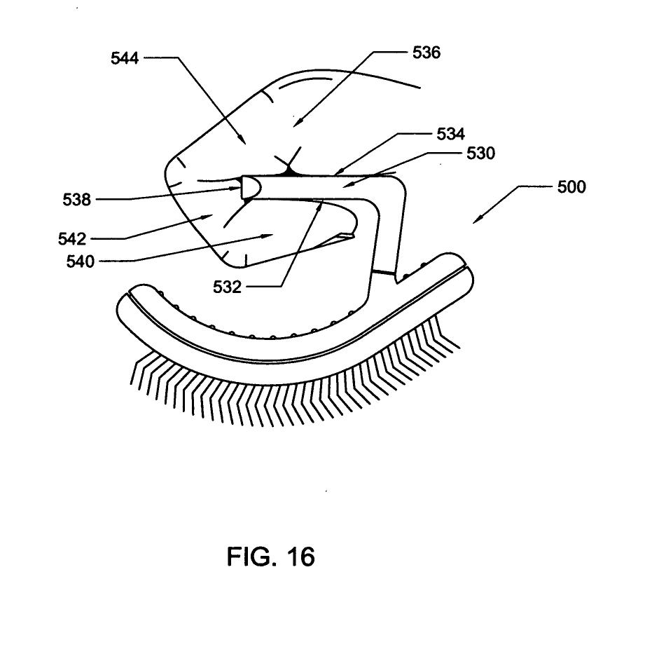

In use, the index finger 536 curls around the upper surface 534, the front side 538 and under the lower surface 532 of the gripping element 530, as shown in FIG. 16. For ease of understanding, the thumb and other fingers are not shown in this Figure. However, the digits of each finger in the two finger or three finger operation will be positioned and function as the digit of the index finger.

The first digit 540 of the index finger will grip the lower surface of the gripping element of the handle section. The spacer element is high enough so the index finger fits between the lower surface of the gripping element and the upper section of the second section of the brush body. The upper surface of the brush element and the gripping element are long enough for one digit of the fingers to fit under the gripping element

The second digit 542 of the index finger grips the front section of the gripping element.

The third digit 544 of the index finger will grip the upper surface of the gripping element .

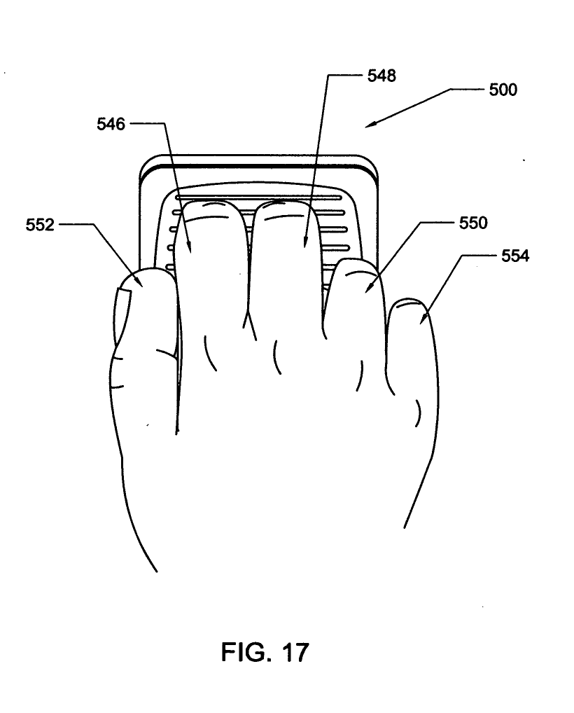

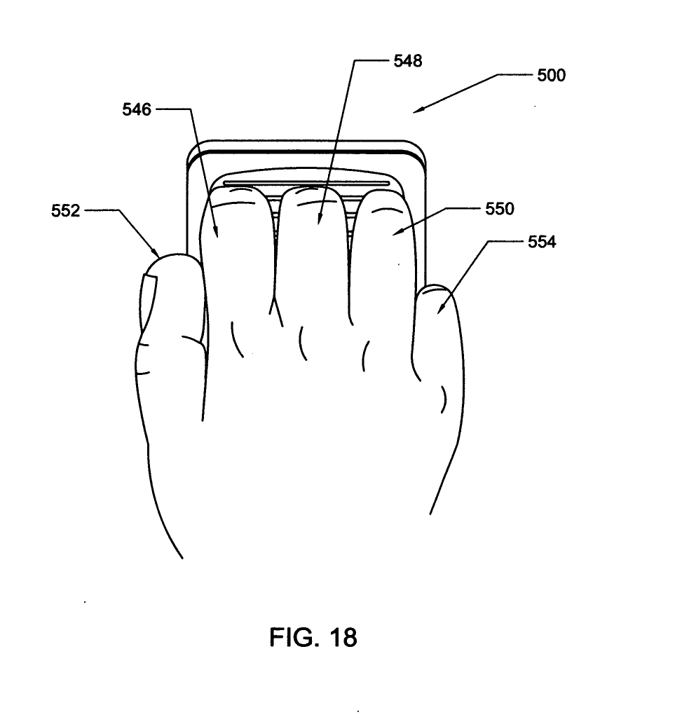

The gripping element of the handle section of the pet brush can be gripped by two finger (the index finger 546 and the middle finger 548 in FIG. 17) or three fingers (the index finger 546, the middle finger 548 and the ring finger 550 in FIG. 18) of the user.

The two fingers of the index finger 546 and the middle finger 548 can grip the upper surface of the gripping element in FIG. 17. The thumb 552 of the user will rest on the index finger or next to the index finger or in air or on the side of the gripping element or on the side of the body brush.

The ring finger 550 and the little finger 554 can rest next to the middle finger or in air or on the side of the gripping element or on the side of the body brush. Neither the thumb nor the ring finger nor the little finger will grip the handle.

One finger or two fingers will be between the gripping element and the brush body and one finger will be on the extension, the finger rest. The fingers will straddle the spacer element.

The three fingers of the index finger 546, the middle finger 548 and the ring finger 550 can grip the upper surface of the gripping element in FIG. 18. The thumb 552 of the user will rest on the index finger or next to the index finger or in air or on the side of the gripping element or the side of the body brush. The little finger 554 can rest next to the ring finger or in air or on the side of the gripping element or the side of the body brush. Neither the thumb nor the little finger will grip the handle.

The dimensions of the pet brush of the present invention are a length of 3.5 to 4.5 inches with a width of 2 to 4 inches.

The base thickness without the bristles is ½ to ¾ of an inch. The bristles extend out ½ to 1 inch from the bottom of the pet brush.

The rise of the pet brush is 1 inch off the handle. The horizontal rise of the pet brush is 1⅝ inch.

The handle width and the riser with is 1½ to 2¾ inches.

The space between the bottom of the horizontal part of the handle and the bottom of the inside curve of the pet brush is 1 inch to 1½ inches.

The first radius of curvature and the second radius of curvature of the pet brush are between 10 inches and 36 inches. In that range, the first radius of curvature can be different from the second radius of curvature. Also in that range, the first radius of curvature can be the same as the second radius of curvature providing a single radius of curvature for the pet brush.

The average length of human fingers is 3 to 4 inches for the index finger, 3½ to 4½ for the middle finger, 3½ to 4½ for the ring finger, and 2½ to 3½ for the little finger. These average fingers will fit over and under the gripping element.

The two or three finger grip on the gripping element of the handle section of the pet brush of the present invention permits downward, upward or sideways motion of the bristles on the brush. This provides a gentle, effective brushing and grooming of the small animal.

The two or three finger grip on the gripping element of the handle section of the pet brush of the present invention allows the pet brush to reach and groom small areas on the pet's hair. The brush basically becomes part of the hand and fingers which hides the pet brush somewhat to make it less threatening when approaching various pets for grooming.

The pet brush of the present invention has no extending handle and is a more compact design with a comparable size bristle section.

Extended handle brushes lead to repetitive stress to arms, wrists and hands of the user. The brush is typically pushed or pulled along a direction that is generally perpendicular to the handle axis during grooming. This can cause considerable strain and fatigue, especially where a user spends a good deal of time brushing.

The pet brush of the present invention the hand, wrist and arm of the user can move in substantially the same downward, upward or sideways direction in which the brush is moved. In this way, hand, wrist or arm fatigue during operation can be avoided due to this positioning and minimal actuation of wrist muscles during usage.

The lower gripping surface of the gripping element can have ridges, etched ridges, dimples, reversed dimples or a tactile or sticky surface for improved gripping. The lower gripping surface of the gripping element can be formed of a different plastic or polymer material (from the rest of the pet brush) for improved gripping.

The pet brush of the second embodiment can be a hand brush.

The vertical element of the handle will be a spacer element and the horizontal element will be a finger restraining element.

The spacer element extends away from the upper surface of the second end of the brush body. The finger restraining extends laterally from the spacer element above the upper surface of the brush body.

The spacer element can be slightly outwardly curved or flat. The finger restraining element can be flat or slightly outwardly curved. The finger restraining element has a lower surface and an upper surface.

The finger restraining element is approximately planar with the first end of the brush body or perpendicular with the upper surface of the brush body adjacent to the first end of the brush body.

The spacer element is at an approximate right angle within 10 degrees plus or minus to the finger restraining element and is angled relative to the upper surface of the second end of the brush body. The spacer element and the gripping element form an inverted L shape.

The spacer element has a height greater the average depth of the fingers of the user. This height allows the fingers to grip the lower surface of the finger restraining element.

The brush body of the pet brush can be gripped by two finger (the index finger and the middle finger) or three fingers (the index finger, the middle finger and the ring finger) of the user.

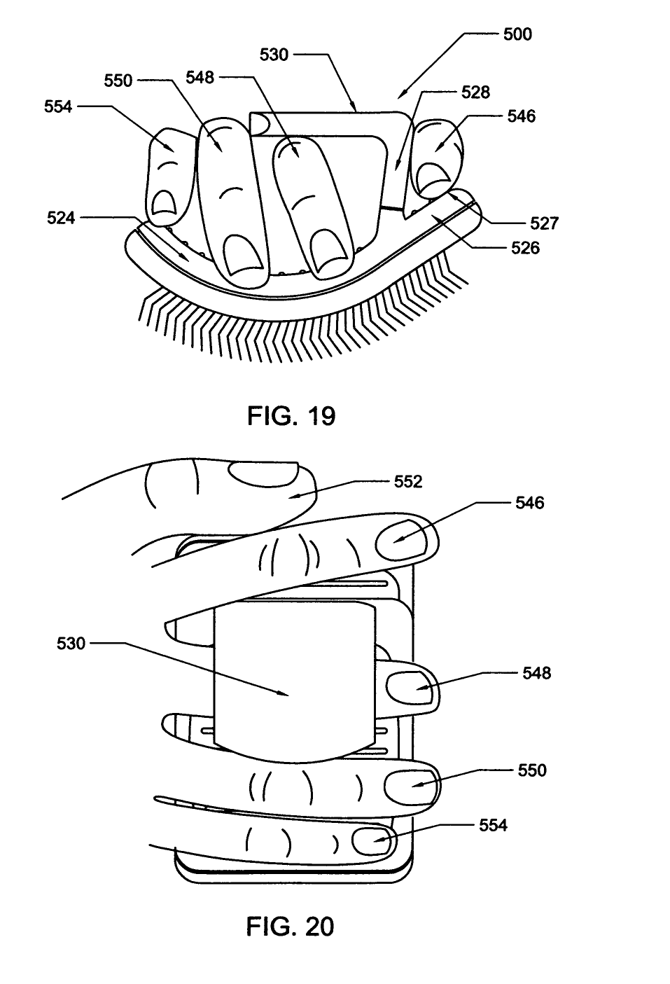

The two fingers of the index finger 546 and the middle finger 548 can grip the upper surface of the brush body in FIGS. 19 and 20.

The index finger 546 will grip the second section 526 of the upper surface of the brush body, adjacent to the spacer element 528 of the handle. The index finger will not be under the finger restraining element 530 but on the extension 527.

The middle finger 548 will grip the first section 524 of the upper surface of the brush body, adjacent to the spacer element of the handle. The middle finger and the index finger will be on opposite sides of the spacer element. The middle finger will be under the finger restraining element 530. The upper surface of the body brush and the finger restraining element will hold the middle finger against the upper surface of the body brush for a better grip.

The thumb 552 will rest on the index finger or next to the index finger or in air or on the side of the body brush.

The ring finger 550 and the little finger 554 can rest next to the middle finger or in air or on the side of the body brush.

Neither the thumb nor the ring finger nor the little finger will grip the brush body.

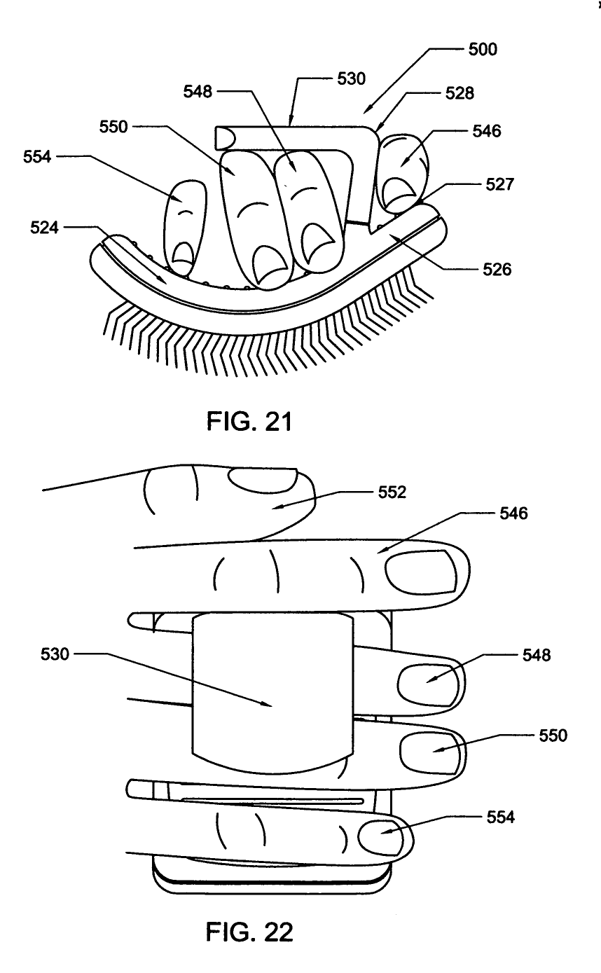

The three fingers of the index finger 546, the middle finger 548 and the ring finger 550 can grip the upper surface of the brush body in FIGS. 21 and 22.

The index finger 546 will grip the second section 526 of the upper surface of the brush body, adjacent to the spacer element of the handle. The index finger will not be under the finger restraining element 530 but on the extension 527.

The middle finger 548 and the ring finger 550 will grip the first section 524 of the upper surface of the brush body, adjacent to the spacer element of the handle. The middle finger and the ring finger will be on opposite sides of the spacer element 528 from the index finger. The middle finger and the ring finger will be under the finger restraining element. The upper surface of the body brush and the finger restraining element will hold the middle finger and the ring finger against the upper surface of the body brush for a better grip.

The thumb 552 will rest on the index finger or next to the index finger or in air or on the side of the body brush. The little finger 554 can rest next to the ring finger or in air or on the side of the body brush. Neither the thumb nor the little finger will grip the brush body.

The lower surface of the finger restraining element will be spaced from the upper surface of the brush body by a distance exceeding the depth of the average fingers of the user. The spacing allows the fingers gripping the upper surface of the gripping element to fit between the lower surface of the finger restraining element and the upper surface of the brush body.

The two or three finger grip on the body brush of the pet brush of the present invention permits downward, upward or sideways motion of the bristles on the brush. This provides gentle, effective brushing and grooming options for the small animal.

The two or three finger grip on the body brush of the handle section of the pet brush of the present invention allows the pet brush to reach and groom small areas on the pet's body. The brush basically becomes part of the hand and fingers which hides the pet brush somewhat to make it less threatening when approaching various pets for grooming.

The pet brush of the present invention has a straight handle and is a more compact design with a comparable size bristle section.

Extended handle brushes lead to repetitive stress to arms, wrists and hands of the user. The brush is typically pushed or pulled along a direction that is generally perpendicular to the handle axis during grooming. This can cause considerable strain and fatigue, especially where a user spends a good deal of time brushing. A brush user can suffer from arthritis or other limiting ailment that prevents gripping a handle brush for extended or limited amounts of time.

In the pet brush of the present invention, the hand, wrist and arm of the user can move in substantially the same downward, upward or sideways direction in which the brush is moved. In this way, hand, wrist or arm fatigue during operation can be avoided due to this positioning and minimal actuation of wrist muscles during usage. The pet brush allows the brush user to free float the brush to move the brush across the pet body without requiring a firm grip.

The upper surface of the body brush can have ridges, etched ridges, dimples, reversed dimples or a tactile surface for improved gripping. The upper surface of the body brush can be formed of a different plastic or polymer material (from the rest of the pet brush) for improved gripping.

The pet brush can be operated by either the left hand or the right hand in the over the handle grip of the gripping section. The pet brush can be operated by either the left hand or the right hand with the fingers along the spacer element and between the finger restraining element and the bush body.

The pet brush of the present invention is unitary construction with an integral handle and body brush. The prior art pet brush has a two part pet brush with a removable handle grip and a bristle base.

The pet brush of the present invention has a smooth surface with no finger or thumb slots.

The prior art patent has a hand grip with finger slots and a thumb slot to position the hand on the grip.

The pet brush of the present invention can be gripped with and over hand grip or by fingers laterally inserted between the brush body and the gripping element with fingers on either side of the spacer element.

The prior art patent pet brush can only be gripped with a closed fist. The prior art patent pet brush has a compartment with side walls for fingers to curve into. These walls limit the placement of fingers outside the walls which limits gripping options (such as placing the fingers between the brush and the grip) and confines fingers to that area and does not allow sliding fingers laterally in from either side. The patent of the present invention has open sides with no restraints on gripping the brush overhand or gripping the brush with fingers between the brush and the grip.

The pet brush of the present invention can move forward and backward, from side to side and in curved manner and in a petting motion. This permits all areas of a small pet to be dematted and groomed.

The prior art patent pet brush can only be moved substantially parallel to the length of the brush in a forward and backward motion. The finger slots lock the user into the grip and the forward and backward only brushing motion. The patent states that any sideways motion of the brush stresses the pet.

The patent of the present invention is a single unitary element. The prior art patent has a quick release and a spring latch to separate the two sections of a hand grip from the bristle base.

The pet brush of the present invention is one, non-removable, non-replaceable, fixed brush section.

The prior art patent pet brush has two sections: a hand grip and a removable, replaceable brush section.

The pet brush of the present invention has a single integrally connected brush with two different bristle sets, one bristle set for dematting animal hair and the other bristles set for grooming animal hair. The dematting set of bristles can be wire and the grooming bristles can be soft bristles. The pet brush of the present invention can have two different bristle sets, one bristle set for breaking out loose hair of the animal and one set for providing a finish to the hair.

The prior art patent pet brush has removable bristle bases with each bristle base having different bristles performing a single different brush function.

The pet brush of the present invention is a handle brush and a hand brush. The prior art patent is just a handle brush. It has a collar partially around the upper surface to receive the hand grip. The collar prevents the prior art pet brush from being used as a hand brush with the hand unable to grip the bristle base.

The pet brush of the present invention is designed for small pets and for grooming hard to reach areas on small pets. The prior art patent is a large brush intended for large pets. It is too large to use effectively on small pets and too large to use on hard to reach areas of small pets. The pet brush of the present invention can be used on small, medium and large pets.

By changing the gripping options, the pet brush of the present invention can groom and brush in any direction in a controlled manner by the user. The pet brush is designed for small pets (but can be used on medium and large pets) and to reduce their stress during grooming. The prior art pet brush is mainly brushing linearly back and forth in one direction which limits the use on a small pet and increases stress during grooming for a small pet.

While the invention has been described with the inclusion of specific embodiments and examples, it is evident to those skilled in the art that many alternatives, modifications and variations will be evident in light of the foregoing descriptions. Accordingly, the invention is intended to embrace all such alternatives, modifications and variations that fall within the spirit and scope of the appended claims.

1. A pet brush comprises
an outwardly curved brush body, said outwardly curved brush body have a lower surface and an upper surface, fixed bristles extending outward from said lower surface of said outwardly curved brush body, said outwardly curved brush body having a first end and a second end; and
a handle section, said handle element being integrally formed with said outwardly curved brush body, said handle section having a spacer element and a gripping element,
said spacer element extending from said second end of said outwardly curved brush body,
said gripping element extending laterally from said spacer element above said upper surface of said outwardly curved brush body.

2. The pet brush of claim 1 wherein
said outwardly curved brush body has a first section with a first radius of curvature at said first end of said outwardly curved brush body, and a second section with a second radius of curvature at said second end of said outwardly curved brush body, said second radius of curvature being smaller than said first radius of curvature

3. The pet brush of claim 1 wherein
the height of said spacer element is greater than the depth of the fingers of the user of said pet brush; and the width of the upper surface of said gripping element is greater than the width of the index finger, the middle finger and the ring finger of said use; wherein two fingers or three fingers of said hand of said user can grip said gripping element.

4. The pet brush of claim 1 wherein said brush body has two different bristles.

5. The pet brush of claim 54 wherein said two different bristles are first bristles for dematting and second bristles for grooming, said first bristles having first contact with the hair of said pet.

6. A pet brush comprises
an outwardly curved brush body, said outwardly curved brush body having e a lower surface and an upper surface, bristles extending outward from said lower surface of said outwardly curved brush body, said outwardly curved brush body having a first end and a second end; and
a vertical element having a first end and a second end, said first end of said vertical element being integrally formed with brush body, and a horizontal element, said second end of said vertical element being connected to one end of said horizontal element,
said spacer vertical element extending from between said first end and said second end of said outwardly curved brush body,
said horizontal element extending laterally from said vertical element above said upper surface of said outwardly curved brush body,
wherein two or three fingers of said user can grip the horizontal element or wherein two or three fingers of said user can fit between said horizontal element and said brush body.

7. A pet brush comprises
an outwardly curved brush body, said outwardly curved brush body having a lower surface and an upper surface, bristles extending outward from said lower surface of said outwardly curved brush body, said outwardly curved brush body having a first end and a second end; and
a vertical element having a first end and a second end, said first end of said vertical element being integrally formed with brush body, and a horizontal element, said second end of said vertical element being connected to one end of said horizontal element,
said vertical element extending from between said first end and said second end of said outwardly curved brush body,
said horizontal element extending laterally from said vertical element above said upper surface of said outwardly curved brush body,
wherein two or three fingers of said user can fit between said horizontal element and said brush body.

8. The pet brush of claim 7 wherein said index finger can grip the brush body adjacent to said vertical element not under said horizontal element and said middle finger can grip the brush body adjacent to said vertical element between said horizontal element and said brush body.

9. The pet brush of claim 8 wherein said ring finger can grip the brush body between said horizontal element and said brush body.

10. The pet brush of claim 6 wherein
said outwardly curved brush body has a first section with a first radius of curvature at said first end of said outwardly curved brush body, and a second section with a second radius of curvature at said second end of said outwardly curved brush body, said second radius of curvature being smaller than said first radius of curvature

11. The pet brush of claim 6 wherein
the height of said spacer element is greater than the depth of the fingers of the user of said pet brush; and the width of the upper surface of said gripping element is greater than the width of the index finger, the middle finger and the ring finger of said use; wherein two fingers or three fingers of said hand of said user can grip said gripping element.

12. The pet brush of claim 6 wherein said brush body has two different bristles.

13. The pet brush of claim 6 wherein said two different bristles are first bristles for dematting and second bristles for grooming, said first bristles having first contact with the hair of said pet.

14. A pet brush comprises
an outwardly curved brush body, said outwardly curved brush body having a lower surface and an upper surface, bristles extending outward from said lower surface of said outwardly curved brush body, said outwardly curved brush body having a first end and a second end; and
a vertical element having a first end and a second end, said first end of said vertical element being integrally formed with brush body, and a horizontal element, said second end of said vertical element being connected to one end of said horizontal element,
said vertical element extending from between said first end and said second end of said outwardly curved brush body,
said horizontal element extending laterally from said vertical element above said upper surface of said outwardly curved brush body.

15. The pet brush of claim 14 wherein
said outwardly curved brush body has a first section with a first radius of curvature at said first end of said outwardly curved brush body, and a second section with a second radius of curvature at said second end of said outwardly curved brush body, said second radius of curvature being smaller than said first radius of curvature

16. The pet brush of claim 14 wherein
the height of said vertical element is smaller than the width of the upper surface of said horizontal element.

17. The pet brush of claim 14 wherein said brush body has two different bristles.

18. The pet brush of claim 17 wherein said two different bristles are first bristles for dematting and second bristles for grooming, said first bristles having first contact with the hair of a pet.
